(19) United States
(12) Patent Application Publication
(10) Pub. No.: US 2005/0043004 A1
(43) Pub. Date: Feb. 24, 2005

(54) Communication apparatus, electronic equipment with communication functions, communication function circuit, amplifier circuit and balun circuit

(75) Inventors: Yasuhiro Kaizaki, Anpachi-Gun (JP); Tetsuro Sawai, Hashima-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/915,339

(22) Filed: Aug. 11, 2004

(30) Foreign Application Priority Data
Aug. 20, 2003 (JP) 2003-296828
Aug. 20, 2003 (JP) 2003-296829
Feb. 24, 2004 (JP) 2004-047901

(51) Int. Cl. H04B 1/26

(52) U.S. Cl. 455/326

(57) ABSTRACT

A communication apparatus includes, as a plurality of communication functions, an amplifier for amplifying a received signal or a transmitting signal, a balun for converting an unbalanced signal to a balanced signal or converting a balanced signal to an unbalanced signal and a mixer for converting a frequency. A gain reducing unit for reducing a gain of a specific frequency band is installed in at least one of the plurality of communication functions. A band rejection filter, for example, serves as a gain reducing unit and is disposed between a pair of transistors. A plurality of band rejection filters may be so arranged as to be distributed to the plurality of communication functions.

### BACKGROUND OF THE INVENTION

1. Field of the Invention

The present invention relates to communication apparatuses and communication function circuits such as mixer, amplifier and balun. The present invention particularly relates to communication apparatuses suitable for wireless communication which are structured by integrated circuits.

2. Description of the Related Art

A wireless communication apparatus is normally comprised of such functions as an amplifier for amplifying signals inputted to or outputted from an antenna, a balun for converting an unbalanced signal to a balanced signal of an antenna or vice versa, a mixer for carrying out frequency conversion between a radio frequency and a modulation or demodulation frequency, and a PLL for generating a local signal for sending a switch signal of a mixer. With an ordinary wireless communication apparatus, it is a common practice that various filters are provided between such constituent functions so as to prevent interference with unnecessary frequency bands or leakages.

On the other hand, with recent advances in communication techniques, there are increasing cases where neighboring frequency bands are used by different communication systems, and there are even instances where a plurality of communication systems are built into the same portable terminal. As a result, there arise needs to eliminate interference between neighboring frequency bands, which in turn tend to make the filtering arrangement within such a system more complex.

In communication methods using wideband frequencies, there may be cases where prohibited frequency bands are present among the bands used. For example, the ultra-wideband (UWB) communication method is such a method.

As mentioned above, a wireless communication apparatus is comprised of a plurality of communication function circuits, such as an amplifier, a balun and a mixer. However, note that the description herein will center around a mixer. And a mixer that performs frequency conversion in high-frequency radio communications is normally a Gilbert cell mixer, which can achieve low noise and low gain for a relatively low power consumption.

Shown in FIG. 2 is a commonly used Gilbert cell mixer circuit. The Gilbert cell mixer is comprised of a differential transistor pair M1 and M2, which receives RF (radio frequency) signals, and two sets of differential transistor pairs M3, M4 and M5, M6, which receive LO (local oscillator) signals.

Differential input signals RF+ and RF− of RF are inputted to the gates of the differential transistor pair M1 and M2. LO+ of the LO differential signals is inputted to the gates of the transistors M3 and M6, and LO− to the gates of the transistors M4 and M5.

A current source transistor is formed on the source side of the differential transistor pair M1 and M2. Differential RF signals inputted to the transistors M1 and M2 are converted into differential currents, which are then switched in response to LO signals inputted to the gates of the transistors M3 to M6. And the thus frequency-converted signals are outputted from the ends of the transistor side of load resistors RL1 and RL2 as differential signals IF+ and IF−.

The Gilbert cell mixer has gains of the outputted frequency-converted signals (IF signals for a down converter) in a wide band though the gains are getting smaller as the frequencies of inputted RF signals become higher.

A Gilbert cell mixer circuit is, for example, disclosed in Reference (1) in the following Relate Art List.

Related Art List

(1) Japanese Patent Application Laid-Open No. 2000-138537 (page 2, FIG. 8).

### SUMMARY OF THE INVENTION

The present invention has been made in view of the foregoing circumstances and an object thereof is to provide a technology for effectively reducing the interference between neighboring frequency bands. Still another object thereof is to provide a technology suitable for wideband communications.

A communication apparatus according to the present invention, includes, as a plurality of communication functions, at least two functions among an amplifier for amplifying a received signal or a transmitting signal, a balun for converting an unbalanced signal to a balanced signal or converting a balanced signal to an unbalanced signal and a mixer for converting a frequency. And this communication apparatus includes a gain reducing means for reducing a gain of a specific frequency band in at least one of the plurality of communication functions.

The gain reducing means is a filter such as low-pass filter, high-pass filter, band rejection filter or the like. Such a filter may have a means for varying frequency characteristics.

The gain reducing means can vary a frequency band with which to reduce the gain, and may include an input means for inputting signals by which to vary the gain-reducing frequency band.

According to the present invention as described above, the gain of a specific frequency band is reduced in the communication functions by the gain reducing means such as a band rejection filter installed in the communication function. By implementing such a structure, there is provided a communication apparatus which can effectively reduce the interference caused by a frequency band in close proximity thereto.

The present invention is preferably applied to the wideband communication like UWB. In the wideband communication there may be a case where a partially prohibited band exists in a given band. However, according to the present invention, the gain of the prohibited band can be effectively reduced by a gain reducing means which is installed inside the communication function, so that communication apparatus suitable for the wideband communication can be provided.

According to a preferable embodiment of the present invention, a plurality of gain reducing means are provided so as to be distributed to a plurality of communication functions. The plurality of gain reducing means may have characteristics by which gains of different frequency bands are reduced. The plurality of gain reducing means may have characteristics by which gains of a similar frequency band are reduced. The plurality of gain reducing means may have characteristics by which gains of different frequencies in close proximity to one another are reduced. And the characteristics of the plurality of gain reducing means may be set so that a gain of a predetermined range of frequency band is reduced by synthesizing frequency bands where the plurality of gain reducing means reduce the gains.

A communication function including the gain reducing means may include a transistor, and the gain reducing means may be a filter disposed between the transistor and ground. The gain reducing means may be a band rejection filter disposed between a pair of transistors.

According to the present invention, if the communication scheme is the same but the permitted frequencies differ among the nations and areas, a means for varying the frequency characteristics of a filter serving as the gain reducing means may be provided. In a communication scheme where a plurality of narrow frequency bands are available and the frequency band is used and changed in a time-series manner and also in compliance with a certain rule, there may be provided a means for varying the frequency characteristics of a filter, serving as the gain reducing means, in a time-series manner according to a frequency used.

Another preferred embodiment of the present invention relates to an electronic apparatus with communication functions. This electronic apparatus includes a communication apparatus comprised of, as a plurality of communication functions, at least two functions among an amplifier for amplifying a received signal or a transmitting signal, a balun for converting an unbalanced signal to a balanced signal or converting a balanced signal to an unbalanced signal and a mixer for converting a frequency. And this electronic apparatus includes a gain reducing means for reducing a gain of a specific frequency band in at least one of the plurality of communication functions.

A communication function circuit according to the present invention constitutes a communication apparatus, and the communication function circuit includes a transistor pair which processes a frequency of a signal related to receiving or transmission thereof. The communication function circuit further includes a filter which is disposed on a signal path formed between sources or emitters of the transistor pair. The communication function circuit is, for example, a mixer, an amplifier or a balun. The filter is, for example, a band rejection filter.

According to the present invention as described above, the gain of a specific frequency band is reduced by a filter which is additionally provided inside a communication function circuit. According to the present invention, the interference between neighboring frequency bands can be effectively reduced without using any filters provided externally to the communication function circuit.

Moreover, the present invention is preferably applied to the wideband communication like UWB. In the wideband communication there may be a case where a partially prohibited band exists in a given band, and the band setting differs from that in the conventional practice. The band is narrow in the conventional practice, and the band setting like this was not taken into account. However, according to the present invention, the gain of the prohibited band can be effectively reduced by a gain reducing means which is installed inside the communication function circuit, so that a communication technology suitable for the wideband communication can be provided.

Still another preferred embodiment according to the present invention relates to a communication function circuit like a mixer. This communication function circuit has two sets of differential transistor pairs a pair of which inputs a first differential signal and the other pair of which inputs a second differential signal and a set of load resistors or load transistors, wherein current flows from power supply to ground potential via the load resistors or load transistors, the differential transistor pair to which the second differential signal is inputted and the differential transistor pair to which the first differential signal is inputted and wherein a frequency-converted signal is outputted from between the load resistors or load transistors and the differential transistor pair to which the second differential signal is inputted. And this mixer circuit further includes a band rejection filter provided in a signal path formed between source electrodes or emitter electrodes of the differential transistor pair to which the first differential signal is inputted.

Electrical characteristics of constituent elements of the band rejection filter may be arranged symmetrically as seen from each of the source or emitter electrodes of the differential transistor pair.

A communication function circuit is provided with a plurality of inductors or resistors between the source electorodes or emitter electrodes of the differential transistor pair, wherein the plurality of inductors or resistors and the ground potential may be short-circuited or coupled via at least one inductor or resistor or via a series circuit of an inductor and a resistor, and wherein between each of the source electrodes or emitter electrodes of the differential transistor pair and the ground potential there may be provided a band rejection filter having a series circuit that contains at least one capacitor and at least one inductor or resistor.

A communication function circuit is provided with two inductors or resistors between the source electrodes or emitter electrodes of the differential transistor pair, wherein a connection point of the two inductors or resistors and the ground potential may be short-circuited or coupled via at least one inductor, and wherein between each of the source electrodes or emitter electrodes of the differential transistor pair and the ground potential there may be provided a band rejection filter having a series circuit of an inductor and a capacitor.

A communication function circuit is provided with two parallel circuits of a capacitor and an inductor in series between the source electrodes or emitter electrodes of the differential transistor pair and wherein a connection point of the parallel circuits of a capacitor and an inductor and the ground potential may be short-circuited or coupled via at least one inductor or resistor or wherein there may be provided a band rejection filter coupled via a series circuit of an inductor and a capacitor.

A communication function circuit may be structured such that at least one capacitor is connected in series between the source electrodes or emitter electrodes of the differential transistor pair, wherein between the source electrodes or emitter electrodes of the differential transistor pair two inductors may be connected in series, and wherein a connection point of the two inductors and the ground potential may be short-circuited or coupled via at least one inductor or resistor or wherein there may be provided a band rejection filter coupled via a series circuit of an inductor and a capacitor.

A communication function circuit may be structured such that there is provided a band rejection filter including: an inductor inserted between the source electrodes or emitter electrodes of the differential transistor pair and the ground potential; and a capacitor connected in parallel with the inductor.

A communication function circuit may be structured such that a parasitic resistor component load or a resistor is connected in series with an inductor provided between the source electrodes or emitter electrodes of the differential transistor pair.

Still another preferred embodiment according to the present invention relates to an amplifier circuit. This amplifier circuit includes a transistor pair and a load resistor or load transistor between the transistor pair and power supply, wherein a signal is outputted from between the transistor pair and the load resistor or load transistor. And this amplifier circuit further includes a band rejection filter provided in a signal path formed between source electrodes or emitter electrodes of the transistor pair.

Still another preferred embodiment according to the present invention relates to a balun circuit. This balun circuit includes a transistor pair and a load resistor or load transistor between the transistor pair and power supply, wherein a signal is outputted from between the transistor pair and the load resistor or load transistor. And this balun circuit further includes a band rejection filter provided in a signal path formed between source electrodes or emitter electrodes of the transistor pair.

It is to be noted that any arbitrary combination or recombination of the above-described structural components and expressions changed to a method, a system, a computer program, a recording medium having stored computer programs therein, a data structure and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 illustrates a communication apparatus according to an embodiment of the present invention.

FIG. 2 shows a structure of a Gilbert cell mixer.

FIG. 3 shows a structure of a Gilbert cell mixer added with a filter.

FIG. 4 shows a filter portion extracted from the structure shown in FIG. 3.

FIG. 5 shows another structure of a Gilbert cell mixer added with a filter.

FIG. 6 shows a filter characteristic of the Gilbert cell mixer added with a filter.

FIG. 7 shows a circuit for countermeasuring the distortions and output characteristics thereof.

FIG. 8 shows still another structure of a Gilbert cell mixer added with a filter.

FIG. 9 shows still another structure of a Gilbert cell mixer added with a filter.

FIG. 10 shows still another structure of a Gilbert cell mixer added with a filter.

FIG. 11 shows still another structure of a Gilbert cell mixer added with a filter.

FIG. 12 shows an example of simulation calculation of a filter characteristic of a Gilbert cell mixer added with a filter.

FIG. 13 shows another example of simulation calculation of a filter characteristic of a Gilbert cell mixer added with a filter.

FIG. 14 shows a structure of a differential low-noise amplifier.

FIG. 15 shows a structure of a distributed amplifier.

FIG. 16 shows a structure of a balun.

FIG. 17 shows a structure of another balun.

FIG. 18 illustrates another embodiment where a plurality of filters are distributed to a plurality of communication circuits.

FIG. 19 illustrates another embodiment where a plurality of filters are distributed to a plurality of communication circuits.

FIG. 20 illustrates still another embodiment where a plurality of filters are distributed to a plurality of communication circuits.

FIG. 21 illustrates still another embodiment where a plurality of filters are distributed to a plurality of communication circuits.

FIG. 22 illustrates still another embodiment where a plurality of filters are distributed to a plurality of communication circuits.

FIG. 23 shows still another structure of a Gilbert cell mixer added with a filter.

FIG. 24 shows a structure of a variable-capacitance circuit shown in FIG. 23.

FIG. 25 illustrates a structural example of a cellular phone that serves as an example of an electronic apparatus with communication functions.

FIG. 26 illustrates a structural example of a W-LAN base station that serves as an example of an electronic apparatus with communication functions.

FIG. 27 illustrates a structural example of a W-LAN terminal that serves as an example of an electronic apparatus with communication functions.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

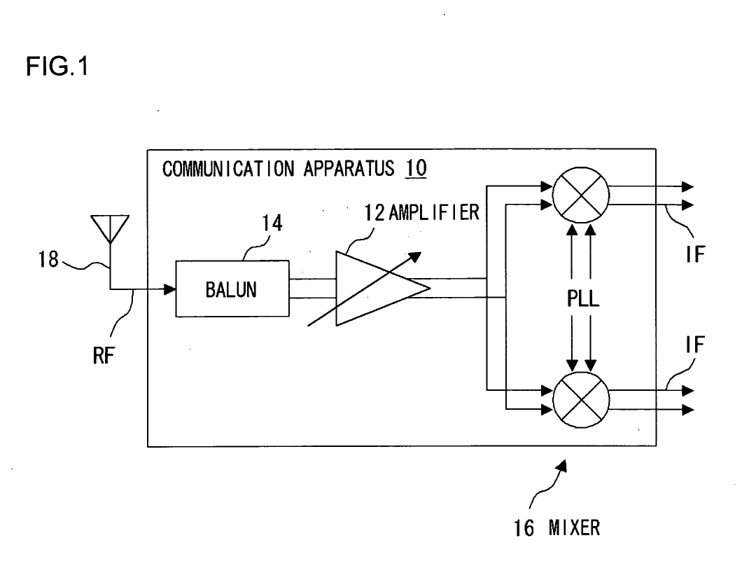

FIG. 1 illustrates an example of a communication apparatus according to a preferred embodiment of the present invention. A communication apparatus 10 as shown in FIG. 1 is a commonly used one for wireless receiving. The communication apparatus 10 may be structured in a single IC circuit. The communication apparatus 10 includes a plurality of communication function circuits, namely, a balun circuit 14, an amplifier circuit 12 and a mixer circuit 16, which are connected in series with each other. In this specification and claim phraseology (WHAT IS CLAIMED), the communication function circuits are referred to simply as communication functions, and, likewise, the balun circuit, the amplifier circuit and the mixer circuit are referred to as the balun, the amplifier and the mixer, respectively. The amplifier 12 is a low-noise amplifier (LNA), which amplifies signals to transmit or receive radio signals. The balun (balun transformer) 14 is an active balun, which converts an unbalanced signal to a balanced signal or vice versa. The mixer 16 is a Gilbert cell mixer, which makes conversion between a radio frequency and a modulation or demodulation frequency.

The balun 14 is connected to an antenna 18. And RF signals are received by the antenna 18. For the RF signal received, the balun 14 converts an unbalanced signal to a balanced signal and vice versa. The signal is amplified by the amplifier 12, and then the mixer 16 outputs an IF signal from the RF signal and an LO (local oscillator) signal generated by a local PLL.

The communication apparatus 10 according to the present embodiment has a built-in gain reducing means for a specific frequency or frequencies provided in at least one of the plurality of communication functions. The gain reducing means is a band rejection filter, which is provided on a signal path formed between a pair of transistors. The following description concerns the case where the mixer 16 is provided with a band rejection filter.

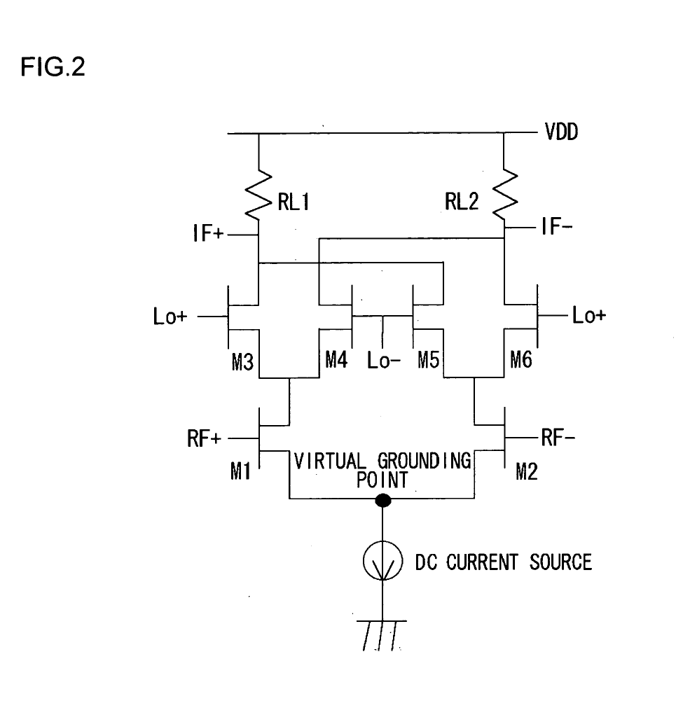

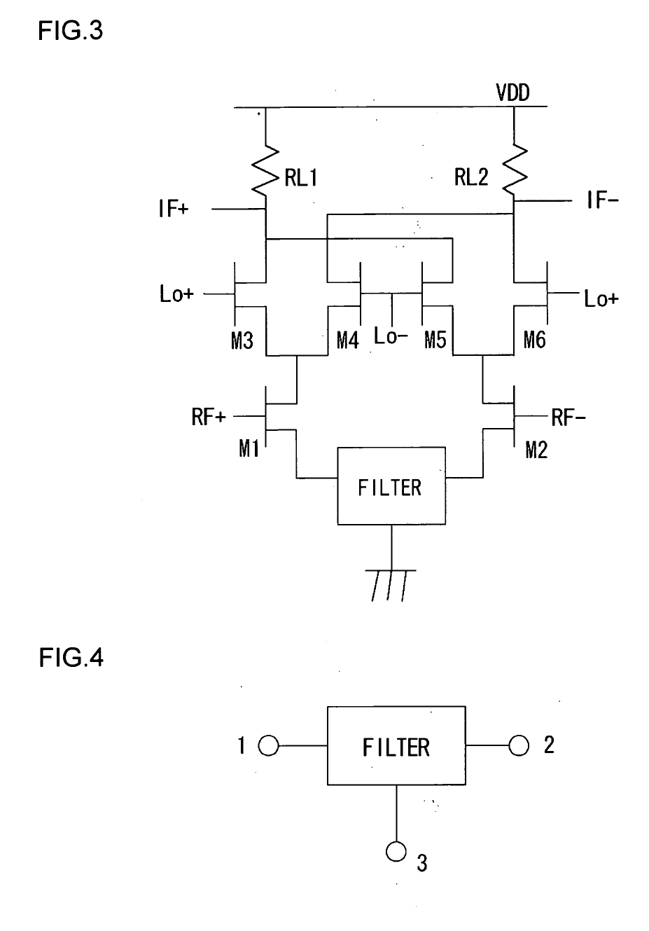

FIG. 3 illustrates a structure of a mixer. Similar to a conventional Gilbert cell mixer as shown in FIG. 2, this mixer is comprised of a differential transistor pair M1 and M2, which receives RF signals, and two sets of differential transistor pairs M3, M4 and M5, M6, which receive LO signals. Here an RF signal corresponds to a first differential signal, and an LO signal to a second differential signal.

The transistors M1 and M2 are n-MOS transistors, and differential RF signals RF+ and RF− are inputted to gate terminals thereof. Drain terminals of the transistors M1 and M2 are electrically coupled to the respective common source terminals of the differential transistor pair M3, M4 and the differential transistor pair M5, M6. LO signals for switching frequency conversion are inputted from gate terminals of the n-MOS transistors M3 to M6. In the electrical connection, LO+ of the LO differential signals is inputted to gate terminals of the transistors M3 and M5 whereas LO− thereof is inputted to gate terminals of the transistors M4 and M5. Drain terminals of the transistors M3 and M5, which are wired in a common connection, are coupled to power supply potential VDD by way of a load resistor RL1 or a transistor load. In the similar manner, drain terminals of the transistors M4 and M6, which are wired in a common connection, are coupled to power supply potential VDD by way of a load resistor RL2 or a transistor load.

With a mixer shown in FIG. 3, inputted RF signals are switched by LO signals and outputted as IF differential signals 1F+ and 1F− from between the load resistors RL1 and RL2 and the drain terminals of the transistors M3 to M6.

As shown in FIG. 3, a band rejection filter is provided between the source terminals of the transistors M1 and M2, which receive RF signals. The band rejection filter herein is so arranged as to have a path for direct current to flow to ground.

Referring to FIG. 4, a circuit network with three terminals, namely, source terminals of the differential transistor pair M1 and M2 of FIG. 3 as port 1 and port 2 respectively and a grounding point as port 3, is now assumed. Also the circuit is formed in such a manner that the impedance of port 1 and port 2 becomes high for a specific frequency, and a band rejection filter is formed between the sources of the transistors M1 and M2. The circuit is also so configured that direct current flows between ports 1 and 3 and between ports 2 and 3.

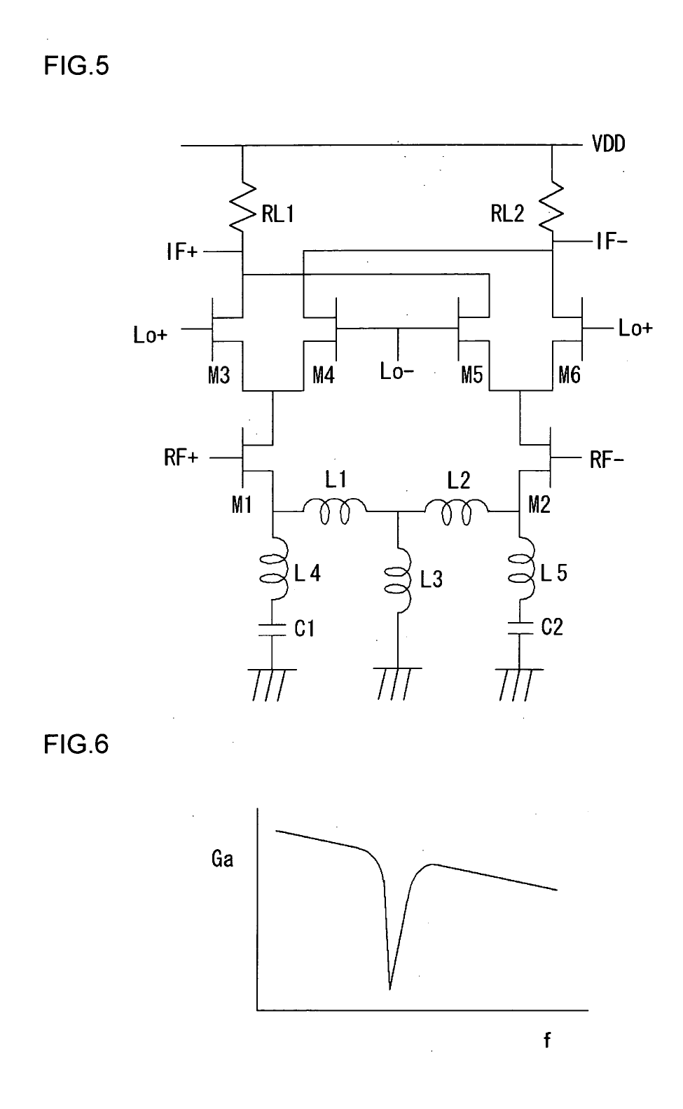

FIG. 5 illustrates an example of a structure of a mixer according to the present embodiment. There is a virtual grounding point between sources of differential transistor pair M1 and M2, which, in terms of AC signals, has high impedance in relation to ground. Inductors L1 and L2 are formed between the sources of the transistor pair M1 and M2 and the virtual grounding point, respectively, and are grounded from the virtual grounding point so as to allow direct current to flow in the mixer. In the case of FIG. 5, an inductor L3 is also formed between the virtual grounding point and ground.

It is to be noted that the virtual grounding point (connection point of inductors L1 and L2) and ground may be short-circuited or coupled via a resistor or via a series circuit of an inductor and a resistor (same applying to the filter to be discussed later).

A series circuit of an inductor and a capacitor is formed from each of the sources of the transistors M1 and M2 to ground. Whereas a series circuit of an inductor L4 and a capacitor C1 is formed from the source of the transistor M1 to ground, a series circuit of an inductor L5 and a capacitor C2 is formed from the source of the transistors M2 to ground.

In this manner, a filter as illustrated in FIG. 5 is comprised of a plurality of inductors (two inductors L1 and L2 in FIG. 5) between the sources of the transistor pair M1 and M2, has a structure coupling the plurality of the inductors with ground potential, and is further provided with series circuits of capacitors and inductors (L4, C1 and L5, C2) between the sources of the transistor pair M1 and M2 and ground potential.

The connection point (virtual grounding point) of the inductors L1 and L2 and ground may be short-circuited or coupled via a resistor or via a series circuit of an inductor and a resistor. Further, a resistor may be provided between the transistor pair M1 and M2. And a resistor may be provided between the transistors M1 and M2 and ground potential. Or a series circuit of a capacitor and a resistor may be provided there.

Here, in the same way as in FIG. 4, a circuit network with three terminals, namely, the source terminals of the differential transistor pair M1 and M2 as port 1 and port 2 respectively and the grounding point as port 3, is assumed. And a band rejection filter is formed between the sources of the transistors M1 and M2 by properly designing the values of inductors and capacitors so that the impedance of port 1 and port 2 becomes high for a specific frequency.

As is well known, filter characteristics are determined according to the relationship of f=½π\sqrt{LC} where f is a resonance frequency.

The value for each circuit element is set symmetrical about the virtual grounding point. Accordingly, the inductors L1 and L2 are of the same magnitude, and likewise the inductors L4 and L5 and the capacitors C1 and C2 are of the same magnitudes, respectively.

In this manner, the electrical characteristics of the constituent elements of the band rejection filter are arranged symmetrically as seen from each of the source terminals of the transistor pair M1 and M2. A symmetrical arrangement like this is also preferably employed by filters of other structures.

Also, where the design value of an inductor is large, a spiral pattern by a micro-strip line needs to be formed on the IC. In such a case, a resistance component may be provided in addition to a parasitic resistor of the inductor so as to improve the linearity of the mixer.

A parasitic resistance component load or a resistor may be connected in series with the inductor which is between the transistor pair M1 and M2. And this arrangement may also be used for other filters.

Moreover, in the present embodiment, capacitors may be connected in parallel with the inductors which are placed between the sources of the differential transistor pair M1 and M2 and ground potential. And this arrangement may also be used for other filters.

By implementing the above structures, direct current of transistors necessary for the operation of a Gilbert cell flows to the ground through inductors, and there appears only a potential drop due to the resistance components of the inductors between the transistors M1 and M2 and the IC ground. Since a narrow-band rejection filter is formed using the resonances of the inductors L1, L2 and the inductor L3 and of the capacitor C1 and the inductor L4 and of the capacitor C2 and the inductor L5, the impedance within a specific band can be made larger. As a result, the conversion gain acquires frequency characteristics as shown in FIG. 6. Hence, the conversion efficiency at specific frequencies can be lowered, thus reducing interference from other communication systems.

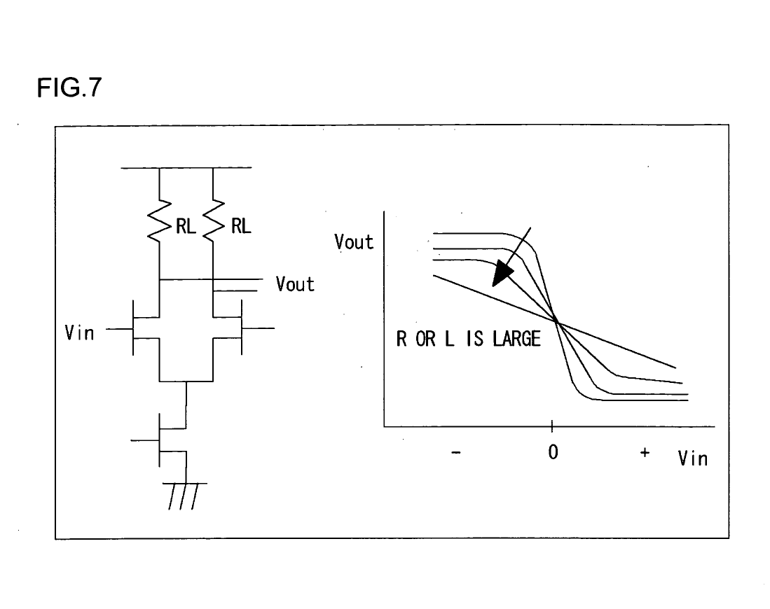

Also as a technique to reduce the mutual modulation distortion of a mixer, the technique of inserting an inductor or a resistor between the sources of a differential transistor pair and the virtual grounding point is used generally. If an impedance is provided between the sources of a differential transistor pair and the virtual grounding point, the gain of output signals for the signals inputted from the gates of the differential transistor pair as shown in FIG. 7 will be reduced. However, the linearity improves. Thus, an advantageous effect like this can be obtained.

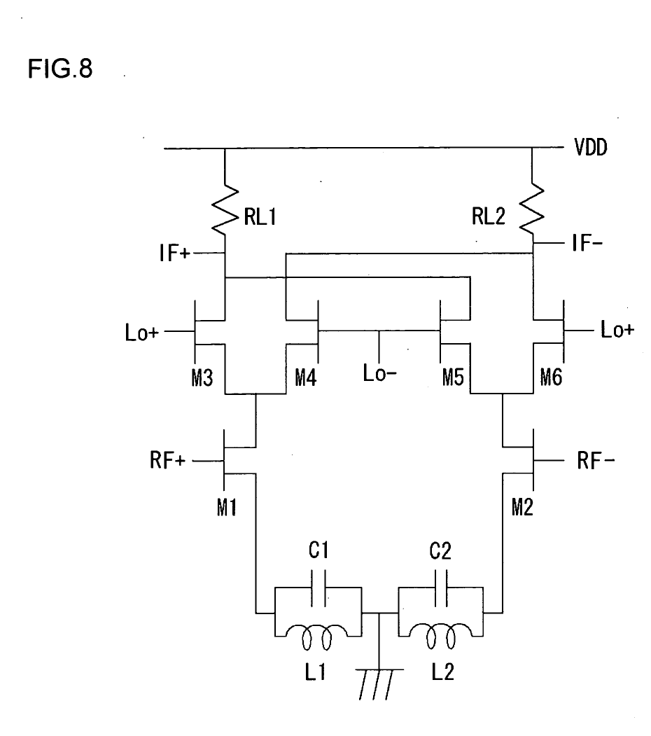

FIG. 8 illustrates an example of another structure of a mixer. The mixers of FIG. 8 and FIG. 5 share the same basic structure excepting their filter structures.

In FIG. 8, inductors L1 and L2 of the same magnitude are formed between the source terminals of transistor pair M1 and M2, to which RF signals are inputted. The connection point (virtual grounding point) G1 of the inductors L1 and L2 are grounded to an IC ground. As aforementioned, an inductor may be provided between the virtual grounding point and the IC ground. In the structure of FIG. 8, capacitors C1 and C2 are further provided to form parallel circuits with the inductors L1 and L2, respectively.

Thus, the filter as illustrated in FIG. 8 has two parallel circuits of a capacitor and an inductor in series between the sources of the transistor pair M1 and M2, and is structured such that the connection point of the parallel circuits is grounded to ground potential. It is to be noted here that the connection point and ground potential may be short-circuited with each other or coupled via an inductor as described above or via a resistor or via a series circuit of an inductor and a resistor.

In this circuit structure, direct current of transistors necessary for the operation of a Gilbert cell flows to the ground through inductors, and there appears only a potential drop due to the resistance components of the inductors between the transistors M1 and M2 and the IC ground. Since a narrow-band rejection filter is formed using the resonances of the pair of the inductor L1 and the capacitor C1, and the pair of the inductor L2 and the capacitor C2, the impedance within a specific band can be made larger. As a result, the conversion efficiency at specific frequencies can be lowered in this structure as shown in FIG. 6.

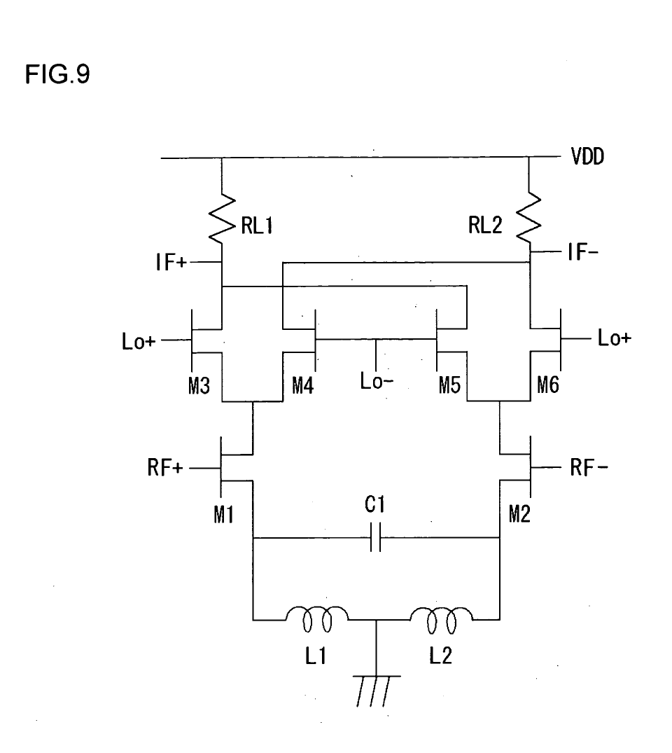

FIG. 9 illustrates an example of still another structure of a mixer. The mixer of FIG. 9 also shares the same basic structure with that of FIG. 5 excepting its filter structure.

In the mixer of FIG. 9, inductors L1 and L2 of the same magnitude are formed between the source terminals of transistor pair M1 and M2, to which RF signals are inputted. The connection point (virtual grounding point) G1 of the inductors L1 and L2 are grounded to IC ground. As aforementioned, an inductor may be provided between the virtual grounding point and the IC ground. In the structure of FIG. 9, a capacitor C1 is further provided between the source terminals of the transistor pair M1 and M2.

Thus, the filter as illustrated in FIG. 9 has a capacitor C1 connected between the sources of the transistor pair M1 and M2 and also has two inductors L1 and L2 connected in series between the sources of the transistor pair M1 and M2, and is structured such that the connection point of these inductors L1 and L2 is grounded to ground potential. The connection point and ground potential may be short-circuited with each other or coupled via an inductor as described above or via a resistor or via a series circuit of an inductor and a resistor. A plurality of capacitors, if so arranged, between the sources of the transistor pair M1 and M2 may be connected in series with each other.

By implementing this circuit structure, direct current of transistors necessary for the operation of a Gilbert cell flows to the ground through inductors, and there appears only a potential drop due to the resistance components of the inductors between the transistors M1 and M2 and the IC ground. Since a narrow-band rejection filter is formed using the resonance of the inductors L1 and L2 and the capacitor C1, the impedance within a specific band can be made larger. As a result, the conversion efficiency at specific frequencies can be lowered in this structure, too, as shown in FIG. 6.

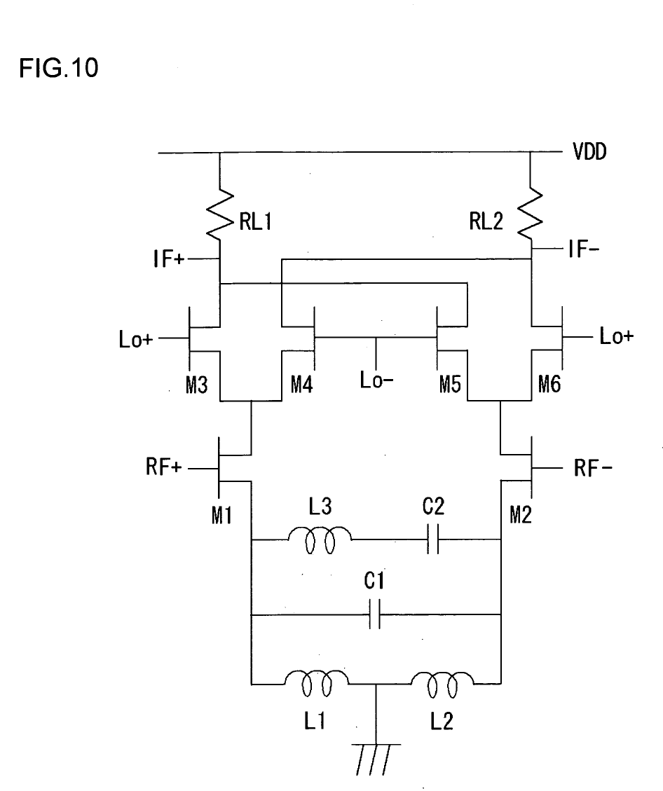

FIG. 10 illustrates an example of still another structure of a mixer. The mixer of FIG. 10 features a structure with a series circuit of an inductor L3 and a capacitor C2 added to the structure of the mixer of FIG. 9. The series circuit of an inductor L3 and a capacitor C2, which is placed between the source terminals of the transistors M1 and M2, are arranged in parallel not only with the inductors L1 and L2 but also with the capacitor C1. In the structure as shown in FIG. 10, there appear two high impedance bands. Hence, it is possible to provide high impedance bands at a plurality of frequencies according to the present embodiment.

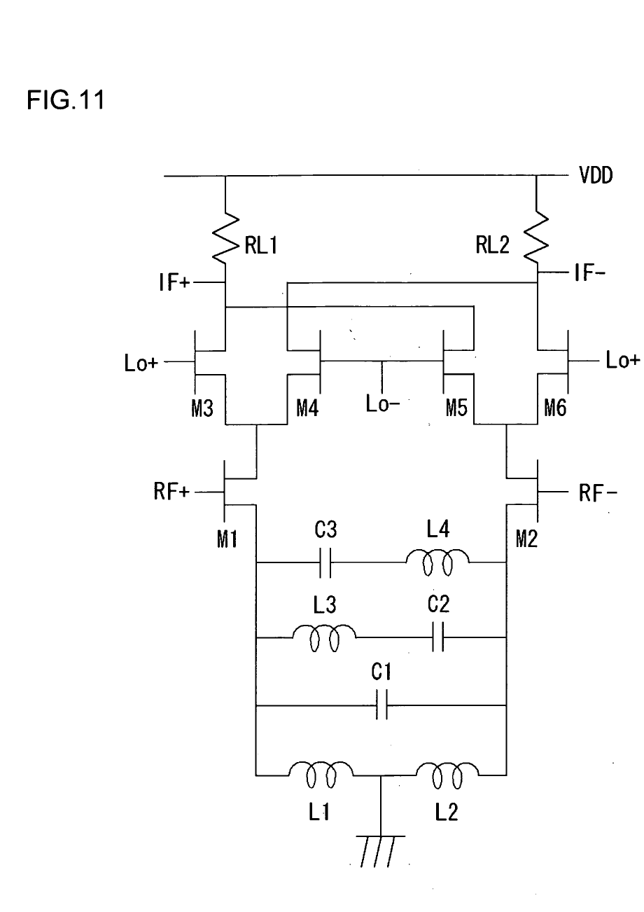

FIG. 11 illustrates an example of still another structure of a mixer. The mixer of FIG. 11 features a structure with a series circuit of an inductor L4 and a capacitor C3 further added to that of the mixer of FIG. 10. In the same manner as with the series circuit of the inductor L3 and the capacitor C2, the series circuit of the inductor L4 and the capacitor C3 is placed between the sources of the transistors M1 and M2. In the structure as shown in FIG. 11, there appear three high impedance bands.

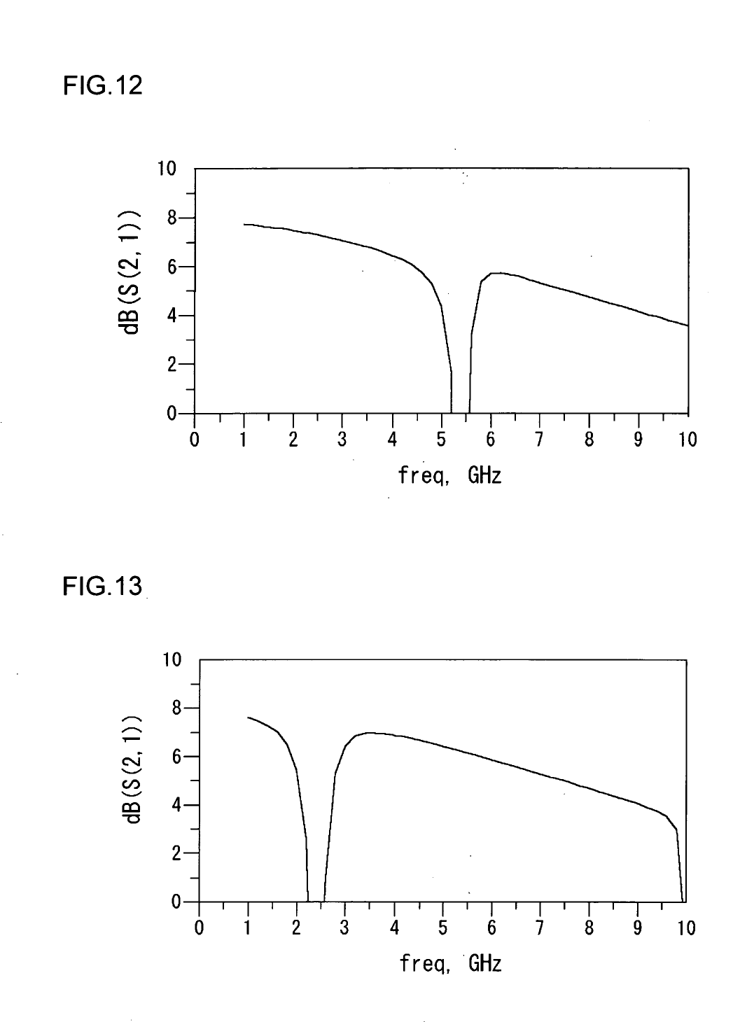

FIGS. 12 and 13 show examples of simulation calculation of filter characteristics. FIG. 12 represents an example of calculation for a circuit of FIG. 9. As is illustrated, high impedance bands appear favorably. On the other hand, FIG. 13 represents an example of calculation for a circuit of FIG. 10. As is illustrated, high impedance shows at two frequencies.

Several of preferred examples, in which a mixer is provided with a band rejection filter, have been described above. In the above description, the differential transistor pair M1 and M2 by which the RF signals are received is n-MOS. However, the differential transistor pair M1 and M2 may be p-MOS. Though a description was given of a down-converting mixer, the same applies for an up-converting mixer.

Although the present invention has been described using FETs, the same applies when bipolar transistors are used. In such a case, a “source” corresponds to an “emitter”, a “gate” to a “base” and a “drain” to a “collector”.

Referring back to FIG. 1, the communication apparatus 10 also includes, as communication functions, the amplifier 12 and the balun 14 in addition to the mixer 16. Similar to the case with the mixer 16, the amplifier 12 and/or the balun 14 may be provided with a band rejection filter. A description will be given hereinbelow of this point.

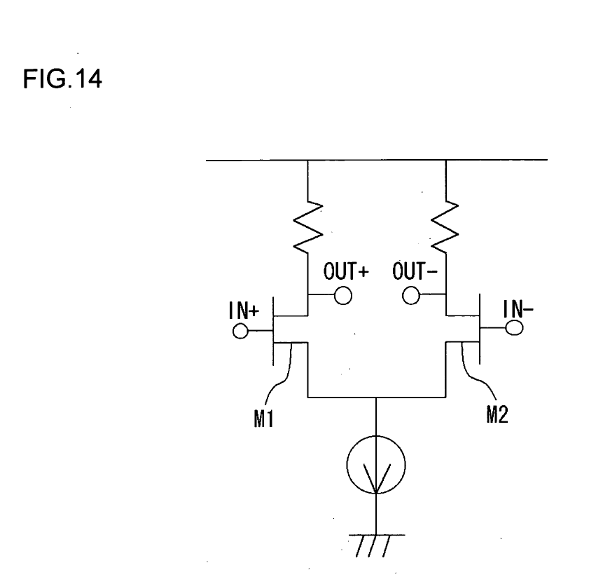

FIG. 14 illustrates a basic circuit of a differential low-noise amplifier. A variety of optional circuits will normally be further included in the structure shown in FIG. 14. The low-noise amplifier has a transistor pair M1 and M2. The signals are inputted from the gates of the transistor pair M1 and M2 and outputted from the drains thereof.

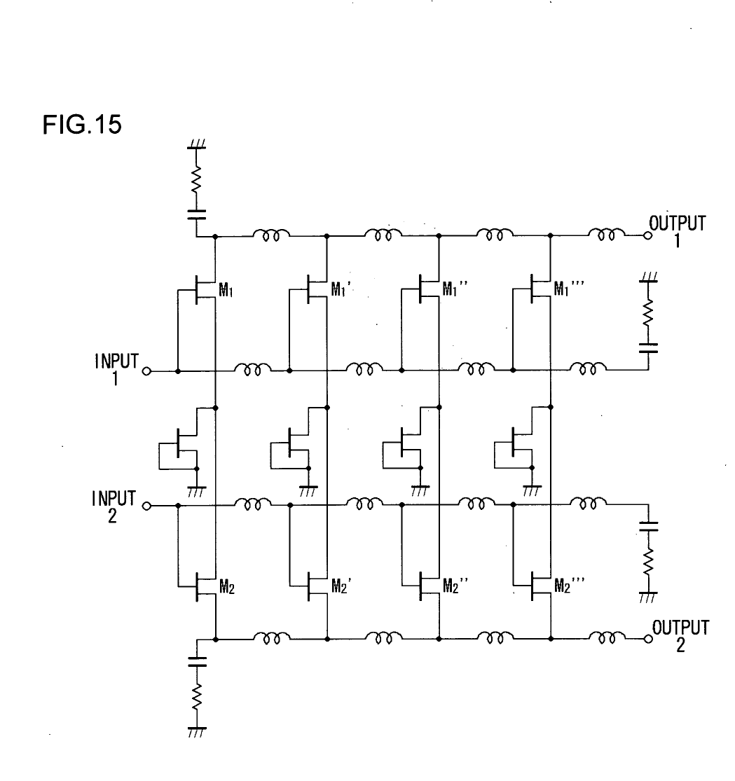

FIG. 15 illustrates a distributed amplifier. The distributed amplifier has a plurality of transistor pairs M1 and M2. The plurality of transistor pairs will be denoted by M1′ and M2′, M1″ and M2″, and M′″ and M2′″. Furthermore, the distributed amplifier is structured such that the input signal is inputted to each differential pair via an inductor or a distributed line.

Thus, similarly to a Gilbert cell mixer, the differential low-noise amplifier or the distributed amplifier is provided with a pair of transistors. The present embodiment has a structure such that a filter as shown in FIG. 3 is added to between a pair of transistors as shown in FIG. 14. Examples of the specific structure for the filter are illustrated in FIG. 5 to FIG. 11. The structures of the filter itself and the mode of implementation may be the same as in the above-described mixer. The description for each filter may be the same as that for the above mixers may and is thus omitted here.

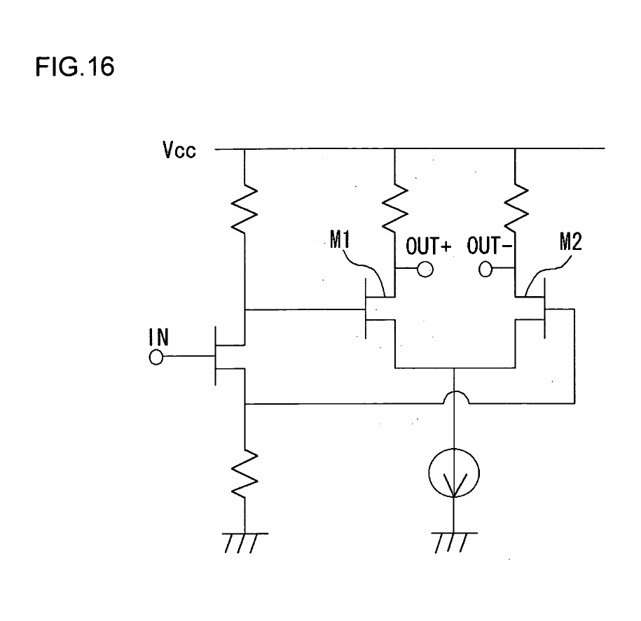

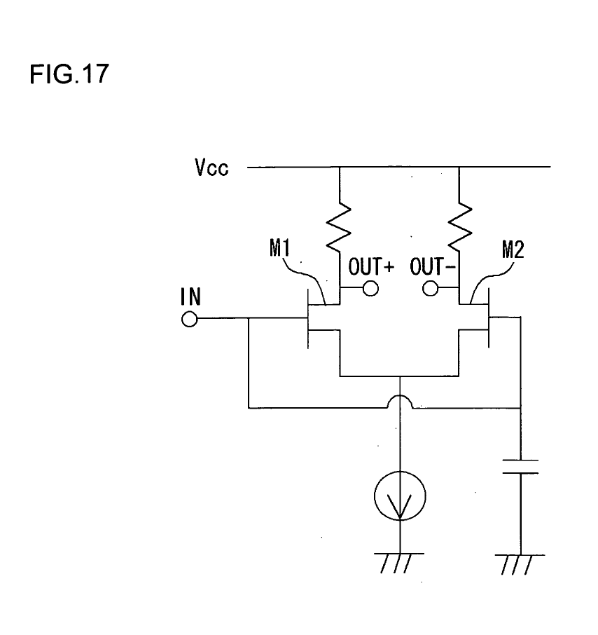

FIGS. 16 and 17 illustrate basic circuits of active balun. In FIGS. 16 and 17 two types of baluns are shown as the basic circuit. In these circuits, an unbalanced signal is inputted from an IN terminal whereas a balanced signal is outputted from OUT+ and OUT− terminals.

As shown in FIGS. 16 and 17, the balun also has a transistor pair M1 and M2. In this embodiment, a structure is such that a filter as shown in FIG. 3 is added to between a transistor pair M1 and M2 as shown in FIGS. 16 and 17. Concrete structural examples of the filter are shown in FIG. 5 to FIG. 11. The structures of the filter itself and the mode of implementation may be the same as in the above-described mixer. The description for each filter may be the same as that for the above mixers and is thus omitted here.

Assumed in the above description are communication functions such as an amplifier, a mixer and a balun. And at least one of these functions is provided with a filter. A plurality of filters may be provided in such a manner that they are distributed to at least two communication functions.

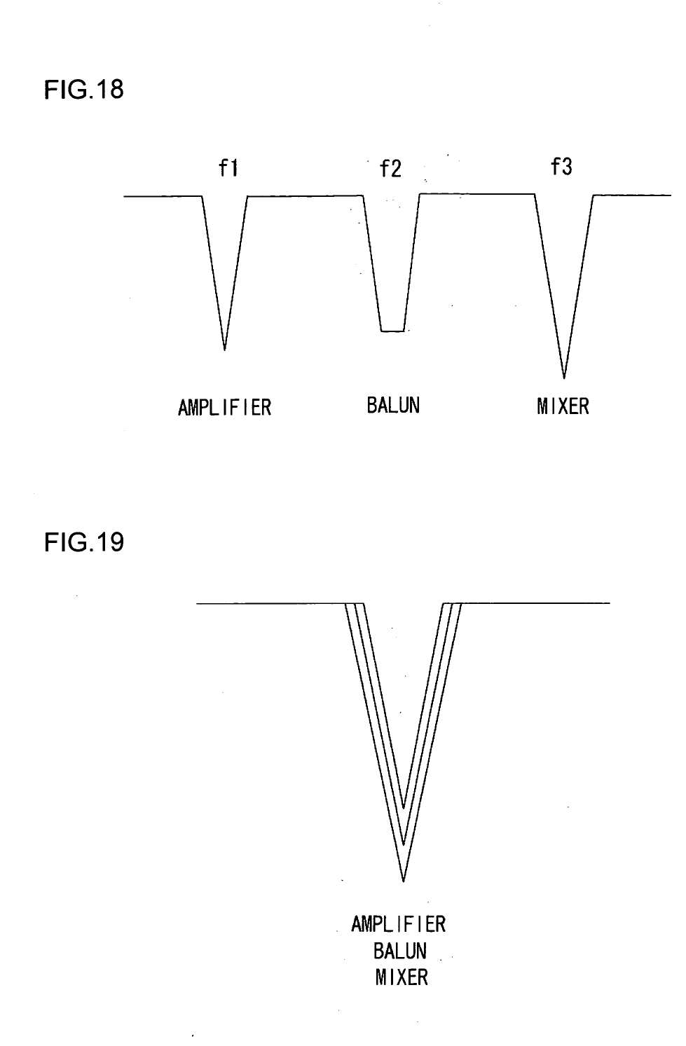

According to this embodiment, the balun, the amplifier and the mixer are provided with band rejection filters, respectively, as shown in FIG. 18. The structure of each filter is selected, for instance, from the examples of filters shown in FIG. 5 to FIG. 11. Referring to FIG. 18, three filters are formed so that the frequency band to be rejected by the filter differs among the balun, the amplifier and the mixer. That is, the filter in the amplifier is so formed as to block the passage of frequency f1. The filter in the balun is so formed as to block the passage of frequency f2. The filter in the mixer is so formed as to block the passage of frequency f3. Thus, in the present embodiment, the gains in a plurality of different frequency bands can be reduced by the communication apparatus 10. As a result, the communication apparatus according to the present embodiment can be applied to a case like a wideband communication where a plurality of different prohibited frequencies are provided.

FIG. 19 illustrates still another embodiment. In this embodiment, too, the balun, the amplifier and the mixer are each provided with a band rejection filter. However, the filters are so formed as to have characteristics such that the three filters reject the same frequency band. In general, the inductance formed on an IC has a low Q-value, so that the attenuation of a filter becomes small. However, with this structure according to this embodiment, a plurality of filters that reject the same frequency band are provided in stages, so that the passage of signals of a certain frequency band can be totally blocked without fail. It is to be noted herein that the “gains of the same frequency band” includes a case of “a similar frequency band” or “an almost same frequency band” as well.

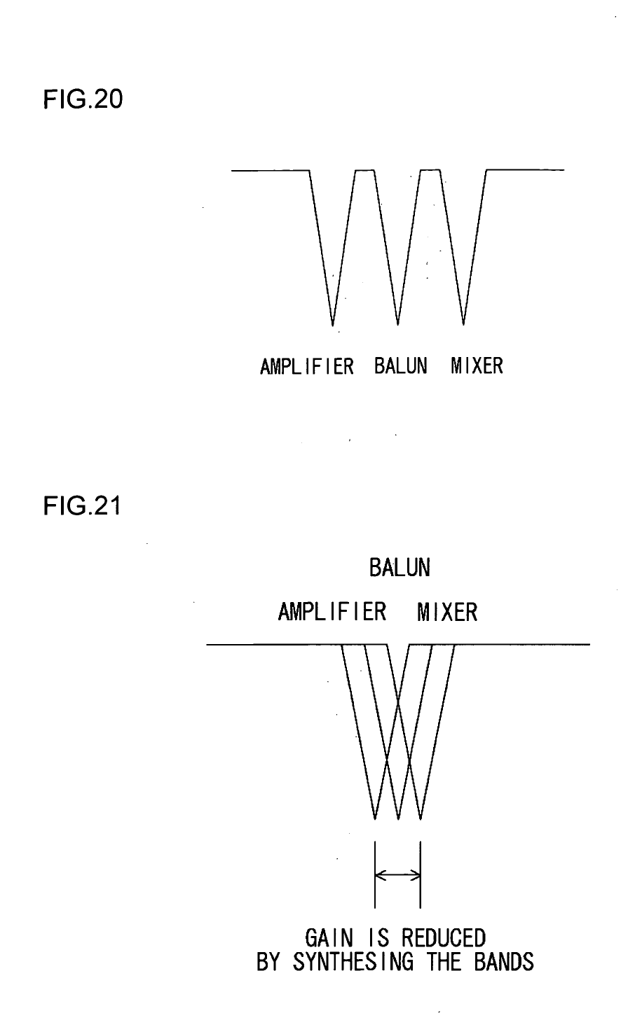

FIG. 20 illustrates still another embodiment. In this embodiment, too, the balun, the amplifier and the mixer are each provided with a band rejection filter. And the three filters are so formed as to have characteristics such that different frequency bands in close proximity are rejected.

Suppose that a single function is provided with the plurality of filters as above, then it may be difficult to achieve a desirable filtering. This is because the frequency bands to be rejected are close to one another and are mutually affected accordingly. In this respect, a structure according to the present embodiment is such that a plurality of filters are distributed among a plurality of communication functions, thus being advantageous in lowering gains of the plurality of neighboring frequency bands.

FIG. 21 illustrates still another embodiment. In this embodiment, too, the balun, the amplifier and the mixer have characteristics such that different frequency bands in close proximity are rejected. Furthermore, three frequency bands to be rejected by three filters are synthesized. Thus, the characteristics of the plurality of filters are set so that a certain range of frequency band is rejected.

According to this embodiment as shown in FIG. 21, the passage of a certain range of frequency band can be blocked by the synthesizing of a plurality of filters. If a sharp characteristic is to be attained by a single filter, it will be not easy to broaden the range of a frequency band to be rejected. Conversely, if the range of a frequency band to be rejected is to be broaden, the sharp characteristic will not be obtained. Here, the sharp characteristic means a characteristic where only part of the frequency band is rejected and frequency bands in the neighborhood thereof are not rejected to the utmost. According to the present embodiment, the usage of a plurality of filters as described above realizes the sharp characteristic and thus enables rejecting the wider range of frequency band.

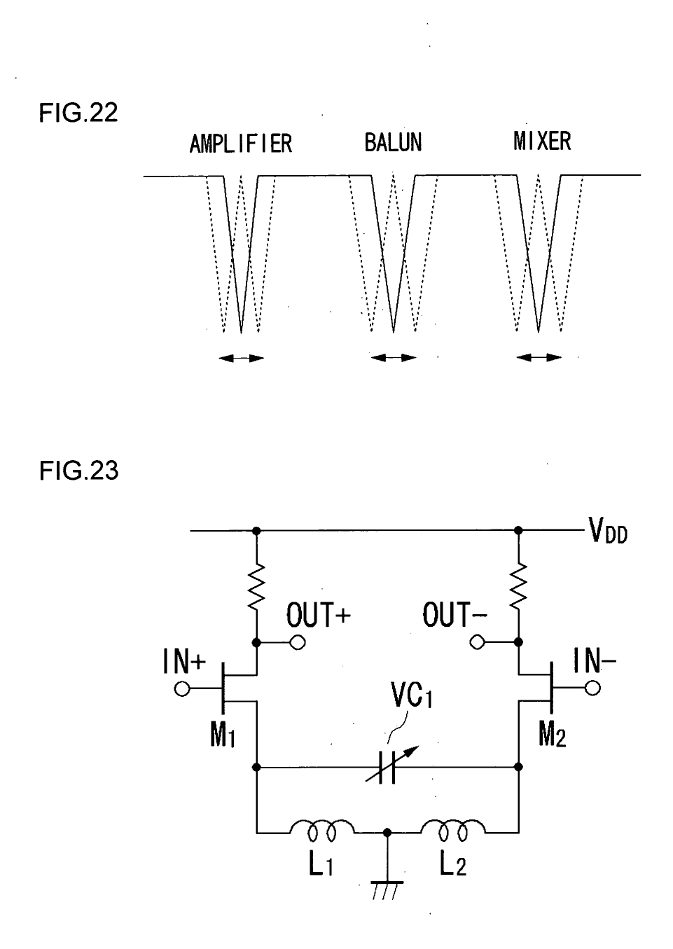

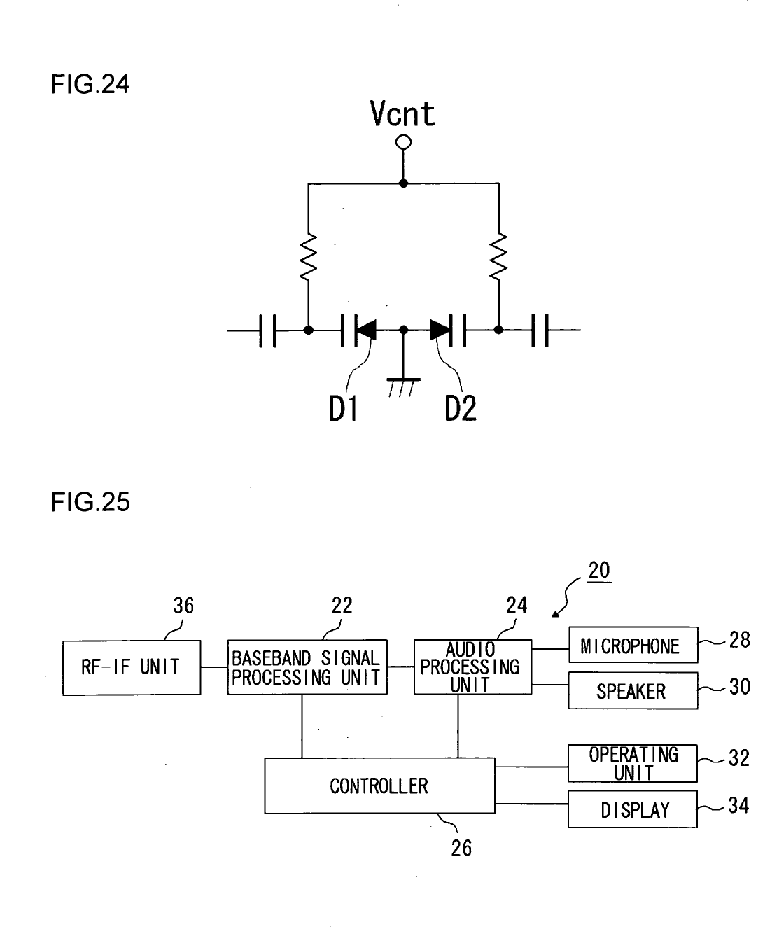

FIG. 22 illustrates still another embodiment. In this embodiment, the center frequency of a filter incorporated in the balun, the amplifier and the mixer is varied so as to vary the frequency band to be rejected. The present embodiment is effective in a case where a communication apparatus is used under a plurality of frequency bands by switching the communication schemes. A circuit implemented to realize the present embodiment is one which utilizes a devices by which the inductance or capacitance can vary, and an actually implemented example of such a circuit is illustrated in FIG. 23. An example of circuit configuration of a variable-capacitance circuit VC1 shown in FIG. 23 is illustrated in FIG. 24. The frequency characteristic of a filter is changed by varying the capacitance of D1 and D2 with voltage Vcnt. Here, the D1 and D2 are varactor diodes incorporated into a circuit.

According to the present embodiments above, the variation of externally applied voltage changes the frequency characteristic of a filter. The present embodiments can effectively cope with the multi-band methods such as UWB whose frequency band in use changes over a short time.

The description has been given of embodiments where a plurality of filters are distributed to a plurality of communication functions. Although the three filters are distributed to the three communication functions in the above embodiments, the arrangement is not limited thereto. For example, two filters may be implemented to two communication functions. As in a case where a mixer is provided with two filters while an amplifier is provided with three filters, part of or entire communication functions may be provided with a plurality of filters (see FIG. 11 and FIG. 12 for example).

The present invention has been described with embodiments involving the communication apparatus and their communication functions that constitute the communication apparatus. Next, a description will be given of electronic apparatus equipped with the communication apparatus.

FIG. 25 illustrates an electronic apparatus with communication functions according to an embodiment of the present invention. In this example, the electronic apparatus is a cellular phone 20. The cellular phone 20 is shown here as an example of electronic apparatus for use with voice communications.

The cellular phone 20 has an audio processing unit 24 and a baseband signal processing unit 22. The audio processing unit 24 and the baseband signal processing unit 22 are controlled by a controller 26. The audio processing unit 24 is connected to a microphone 28 and a speaker 30. The controller 26 is connected to an operating unit 32 and a display 34. The baseband signal processing unit 22 is connected to an RF-IF unit 36 where baseband signals are converted into RF signals so as to be transmitted/received. This RF-IF unit 36, particularly a part thereof which processes the RF signals, corresponds to the communication apparatus shown in FIG. 1. In other words, the RF-IF unit 36 is provided with communication functions such as the above-described mixer. And a filter or filters is/are installed in the communication function.

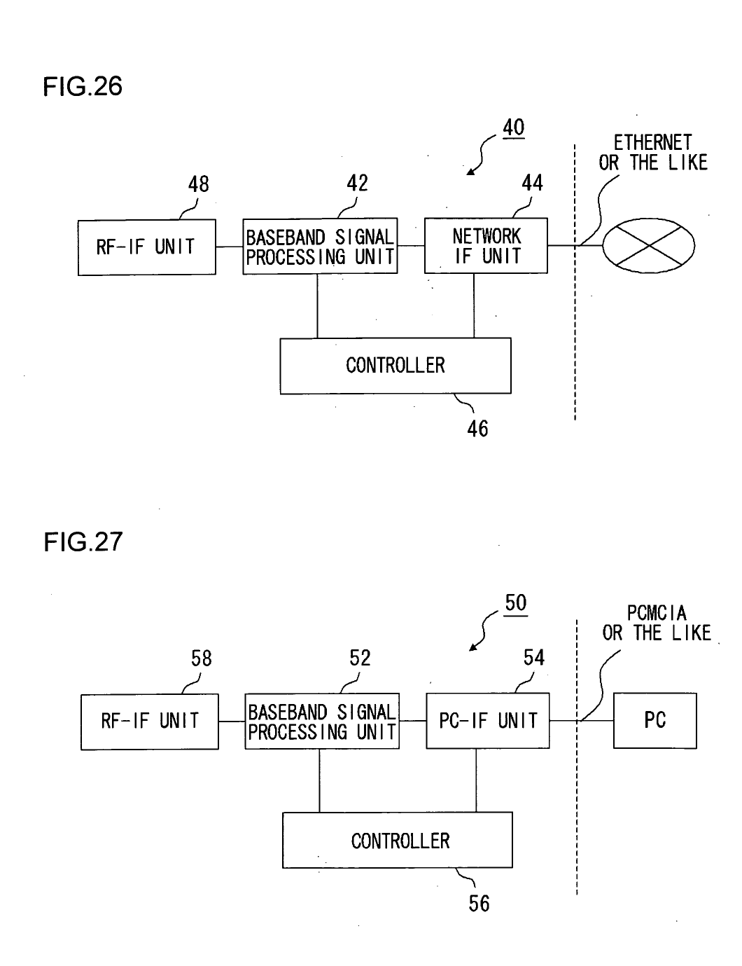

FIG. 26 illustrates another electronic apparatus having communication functions. In this example, the electronic apparatus is a base station 40, which serves as an example of apparatus for use with data communication, and corresponds to a base station of W-LAN (wireless LAN). The base station 40 has a network IF unit 44 and a baseband signal processing unit 42. The network IF unit 44 and the baseband signal processing unit 42 are controlled by a controller 46. The network IF unit 44 is connected to a network via Ethernet (registered trademark) or the like. The baseband signal processing unit 42 is connected to an RF-IF unit 48. This RF-IF unit 48 corresponds to the communication apparatus shown in FIG. 1. In other words, the RF-IF unit 48 is provided with communication functions such as the above-described mixer. And a filter or filters is/are installed in the communication function.

FIG. 27 illustrates still another electronic apparatus having communication functions. In this example, the electronic apparatus is a terminal 50, which serves as an example of apparatus for use with data communication, and corresponds to a terminal of W-LAN. The terminal 50 has a PC-IF unit 54 and a baseband signal processing unit 52. The PC-IF unit 54 and the baseband signal processing unit 52 are connected to a controller 56. The PC-IF unit 54 is connected to another PC via PCMCIA or the like. The baseband signal processing unit 52 is connected to an RF-IF unit 58. This RF-IF unit 58 corresponds to the communication apparatus shown in FIG. 1. In other words, the RF-IF unit 58 is provided with communication functions such as the above-described mixer. And a filter or filters is/are installed in the communication function.

The present invention has been described based on the preferred embodiments. According to the present embodiments, the gain of a specific frequency band is reduced in the communication functions by a gain reducing means such as a band rejection filter installed in the communication function. The gain is reduced inside the communication function. By implementing such a structure, there is provided a communication apparatus which can effectively reduce the interference caused by a frequency band in close proximity to the frequency band in use.

The present invention may be preferably applied to the wideband communication like UWB. As described before, in the wideband communication there may be a case where a partially prohibited band exists in a given band. However, according to the present embodiments, the gain of the prohibited band can be effectively reduced by a gain reducing means which is installed inside the communication function, so that communication apparatus suitable for the wideband communication can be provided.

According to the present invention, attention is directed to communication functions such as mixer and amplifier in the course of examining communication apparatus adapted for the setting of a band in the wideband communication. And the communication function is provided with a gain reducing means so as to reduce part of a gain. Accordingly, there is provided a communication apparatus suitable for the wideband communication in which a prohibited band is partially contained.

In the conventional technology, a structure is such that an inductor or inductors alone is/are provided between the transistor pair. There is also a structure in the conventional practice such that a resistor or resistors alone is/are provided therebetween. There is also a structure in the conventional practice such that a tank circuit is provided between the transistor pair. In this conventional technique, the reflection of signals is intended. In contrast to such conventional techniques, the present invention is characterized in that the signals are trapped by bringing the gain down.

According to the present embodiments, the number of parts used is reduced by integrally structuring an apparatus, thus contributing to the simplification of a filter structure.

Moreover, according to the present embodiments as described above, a plurality of gain reducing means are so provided as to be distributed to a plurality of communication functions. Thus the plurality of gain reducing means function together, so that a desired characteristic in terms of the gain reduction can be obtained. The gain reducing means may typically be a band rejection filter as described above.

As for this point, a structure is such that a plurality of gain reducing means have characteristics by which gains of different frequency bands are reduced. As a result, the gains of a plurality of different frequency bands can be reduced by the communication apparatus.

Moreover, a structure is such that a plurality of gain reducing means have characteristics by which gains of the same frequency are reduced. As a result, the gain of a certain frequency band can be reduced reliably.

Moreover, a structure is such that a plurality of gain reducing means have characteristics by which gains of different frequencies in close proximity thereto are reduced. As a result, the functions of those gain reducing means can be preferably and effectively realized, and more beneficial consequence than that with a case where a plurality of filters are arranged at a single location can be expected.

Moreover, it is preferable that the characteristics of a plurality of gain reducing means are set so that a gain of a certain range of frequency band is reduced by synthesizing frequency bands where the plurality of gain reducing means reduce the gains. As a result, the reduction in the gain of a certain range of frequency band can be realized together with the attainment of sharp characteristics.

Moreover, in the present invention the communication function circuit may be provided with a plurality of filters. In such a case, a plurality of high impedance bands may be provided between a pair of transistors. Examples of this sort are shown in FIG. 10 and FIG. 11.

According to the present invention, the frequency characteristic can be adjusted so that a specific frequency band only can be transmitted or received.

Moreover, according to the present invention as described above, a plurality of filters are so provided as to be distributed to a plurality of communication function circuits. Thus, the plurality of filters function together and the desired filter characteristics can be obtained. This advantageous aspect of the present invention was described with reference to FIGS. 18 to 21 using examples.

The present invention has been described based on the embodiments which are only exemplary. It is therefore understood by those skilled in the art that there exist other various modifications to the combination of each component and process described above and that such modifications are also encompassed by the scope of the present invention. For example, a communication apparatus according to the present invention is, within the scope of the present invention, not limited to those with a structure shown in FIG. 1 and the arrangement of communication functions in the communication apparatus may differ from that shown in FIG. 1. The arrangement of active balun and low-noise amplifier may be in the reverse order. The communication functions installed in the communication apparatus may be arranged differently from the arrangement of the active balun, the low-noise amplifier and the mixer shown in FIG. 1. Moreover, the communication apparatus may be one for use with the receiving, and in such a case any modification may be made to be suitable for the receiving. Although the function circuits described in the present embodiments are of differential type for example, the function circuit may be of unbalanced type having a built-in filter.

Although the present invention has been described by way of exemplary embodiments, it should be understood that many changes and substitutions may further be made by those skilled in the art without departing from the scope of the present invention which is defined by the appended claims.

1. A communication apparatus, including, as a plurality of communication functions, at least two functions among an amplifier for amplifying a received signal or a transmitting signal, a balun for converting an unbalanced signal to a balanced signal or converting a balanced signal to an unbalanced signal and a mixer for converting a frequency, the apparatus including:
a gain reducing means for reducing a gain of a specific frequency band in at least one of the plurality of communication functions.

2. A communication apparatus according to claim 1, wherein a plurality of gain reducing means are distributed to a plurality of communication functions.

3. A communication apparatus according to claim 2, wherein the plurality of gain reducing means have characteristics by which gains of different frequency bands are reduced.

4. A communication apparatus according to claim 2, wherein the plurality of gain reducing means have characteristics by which gains of a similar frequency band are reduced.

5. A communication apparatus according to claim 2, wherein the plurality of gain reducing means have characteristics by which gains of different frequencies in close proximity to one another are reduced.

6. A communication apparatus according to claim 5, wherein the characteristics of the plurality of gain reducing means are set so that a gain of a predetermined range of frequency band is reduced by synthesizing frequency bands where the plurality of gain reducing means reduce the gains.

7. A communication apparatus according to claim 1, wherein a communication function including said gain reducing means includes a transistor and wherein said gain reducing means is a filter disposed between the transistor and ground.

8. A communication apparatus according to claim 1, wherein a communication function including said gain reducing means includes a transistor pair and wherein said gain reducing means is a band rejection filter disposed between the transistor pair and ground.

9. An electronic apparatus with communication functions, including a communication apparatus comprised of, as a plurality of communication functions, at least two functions among an amplifier for amplifying a received signal or a transmitting signal, a balun for converting an unbalanced signal to a balanced signal or converting a balanced signal to an unbalanced signal and a mixer for converting a frequency, the electronic apparatus including:
a gain reducing means for reducing a gain of a specific frequency band in at least one of the plurality of communication functions.

10. A communication function circuit constituting a communication apparatus, the circuit including:
a transistor pair which processes a frequency of a signal related to receiving or transmission thereof,
wherein a filter is disposed on a signal path formed between sources or emitters of the transistor pair.

11. A communication function circuit according to claim 10, wherein the filter disposed on a signal path formed between sources or emitters of the transistor pair is a band rejection filter.

12. A communication function circuit, having two sets of differential transistor pairs a pair of which inputs a first differential signal and the other pair of which inputs a second differential signal and a set of load resistors or load transistors, wherein current flows from power supply to ground potential via the load resistors or load transistors, the differential transistor pair to which the second differential signal is inputted and the differential transistor pair to which the first differential signal is inputted and wherein a frequency-converted signal is outputted from between the load resistors or load transistors and the differential transistor pair to which the second differential signal is inputted, the circuit further including:
a band rejection filter provided in a signal path formed between source electrodes or emitter electrodes of the differential transistor pair to which the first differential signal is inputted.

13. An amplifier circuit including a transistor pair and a load resistor or load transistor between the transistor pair and power supply, wherein a signal is outputted from between the transistor pair and the load resistor or load transistor, the amplifier circuit further including:
a band rejection filter provided in a signal path formed between source electrodes or emitter electrodes of the transistor pair.

14. A balun circuit including a transistor pair and a load resistor or load transistor between the transistor pair and power supply, wherein a signal is outputted from between the transistor pair and the load resistor or load transistor, the balun circuit further including:
a band rejection filter provided in a signal path formed between source electrodes or emitter electrodes of the transistor pair.

15. A communication function circuit according to claim 12, wherein electrical characteristics of constituent elements of said band rejection filter are arranged symmetrically as seen from each of the source or emitter electrodes of the differential transistor pair.

16. A communication function circuit according to claim 12, wherein a plurality of inductors or resistors are provided between the source electrodes or emitter electrodes of the differential transistor pair, wherein the plurality of inductors or resistors and the ground potential are short-circuited or coupled via at least one inductor or resistor or via a series circuit of an inductor and a resistor, and wherein between each of the source electrodes or emitter electrodes of the differential transistor pair and the ground potential there is provided a band rejection filter having a series circuit that contains at least one capacitor and at least one inductor or resistor.

17. A communication function circuit according to claim 12, wherein two inductors or resistors are provided between the source electrodes or emitter electrodes of the differential transistor pair, wherein a connection point of the two inductors or resistors and the ground potential are short-circuited or coupled via at least one inductor, and wherein between each of the source electrodes or emitter electrodes of the differential transistor pair and the ground potential there is provided a band rejection filter having a series circuit of an inductor and a capacitor.

18. A communication function circuit according to claim 12, wherein between the source electrodes or emitter electrodes of the differential transistor pair there are provided two parallel circuits of a capacitor and an inductor in series, and wherein a connection point of the parallel circuits of a capacitor and an inductor and the ground potential are short-circuited or coupled via at least one inductor or resistor or wherein there is provided a band rejection filter coupled via a series circuit of an inductor and a capacitor.

19. A communication function circuit according to claim 12, wherein at least one capacitor is connected in series between the source electrodes or emitter electrodes of the differential transistor pair, wherein between the source electrodes or emitter electrodes of the differential transistor pair two inductors are connected in series, and wherein a connection point of the two inductors and the ground potential are short-circuited or coupled via at least one inductor or resistor or wherein there is provided a band rejection filter coupled via a series circuit of an inductor and a capacitor.

20. A communication function circuit according to claim 12, wherein there is provided a band rejection filter including:
an inductor inserted between the source electrodes or emitter electrodes of the differential transistor pair and the ground potential; and a capacitor connected in parallel with the inductor.

21. A communication function circuit according to claim 12, wherein a resistor is connected in series with an inductor provided between the source electrodes or emitter electrodes of the differential transistor pair.
